(19) United States
(12) Patent Application Publication
(10) Pub. No.: US 2023/0186798 A1
(43) Pub. Date: Jun. 15, 2023

(54) Taxi Cab Hailing Assembly

(71) Applicant: Erasmo Figueroa, San Antonio, TX (US)

(72) Inventor: Erasmo Figueroa, San Antonio, TX (US)

(21) Appl. No.: 17/551,833

(22) Filed: Dec. 15, 2021

(51) Int. Cl. G09F 13/04; G09F 7/20; F21V 23/04; G08B 7/06; G08B 21/02

(52) U.S. Cl. CPC G09F 13/0404; G09F 7/20; G09F 13/0463; F21V 23/04; G08B 7/06; G08B 21/02; G09F 2007/1873

(57) ABSTRACT

A taxi cab hailing assembly includes an arm that has a plurality of sections that are pivotally coupled together. The arm is positionable in an extended position or a collapsed position. A handle is provided and the arm is pivotally coupled thereto. The handle is gripped by a user to extend the arm outwardly toward a roadway when the arm is in the extended position. A panel is coupled to the arm thereby facilitating the panel be extended outwardly toward the roadway when the arm is in the extended position. A light emitter is coupled to the panel and the light emitter emits light the light emitter is turned on. In this way the light emitter enhances visibility of the panel to the taxi driver. An alarm is coupled to the handle and the alarm emits an audible alert when the alarm is turned on.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to hailing devices and more particularly pertains to a new hailing device for hailing a taxi cab from a sidewalk.

### (2) Description of Related Art Including Information Disclosed Under 37 CFR 1.97 and 1.98

The prior art relates to hailing devices.

### (h) BRIEF SUMMARY OF THE INVENTION

An embodiment of the disclosure meets the needs presented above by generally comprising an arm that has a plurality of sections that are pivotally coupled together. The arm is positionable in an extended position or a collapsed position. A handle is provided and the arm is pivotally coupled thereto. The handle is gripped by a user to extend the arm outwardly toward a roadway when the arm is in the extended position. A panel is coupled to the arm thereby facilitating the panel be extended outwardly toward the roadway when the arm is in the extended position. A light emitter is integrated into the panel and the light emitter illuminates the panel when the light emitter is turned on. In this way the light emitter enhances visibility of the panel to the taxi driver. An alarm is coupled to the handle and the alarm emits an audible alert when the alarm is turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a taxi cab hailing assembly according to an embodiment of the disclosure.

FIG. 2 is a front phantom view of an embodiment of the disclosure.

FIG. 3 is a perspective view of an embodiment of the disclosure showing an arm in an extended position.

FIG. 4 is a top view of an embodiment of the disclosure.

FIG. 5 is a perspective in-use view of an embodiment of the disclosure.

### (j) DETAILED DESCRIPTION OF THE INVENTION

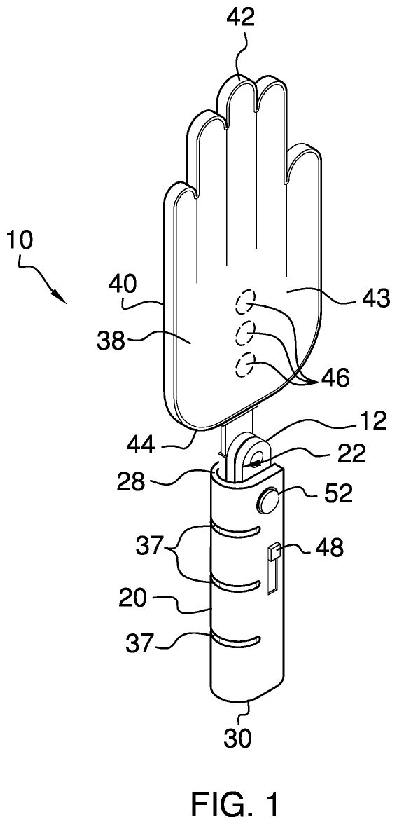

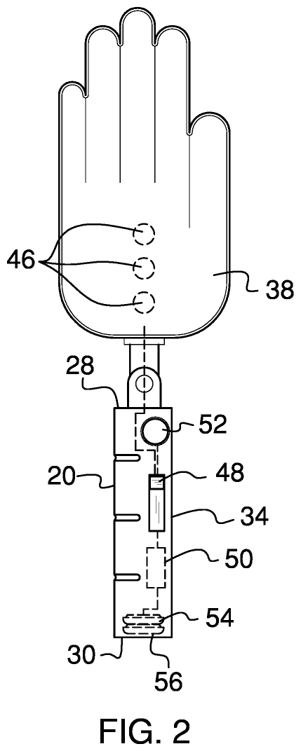

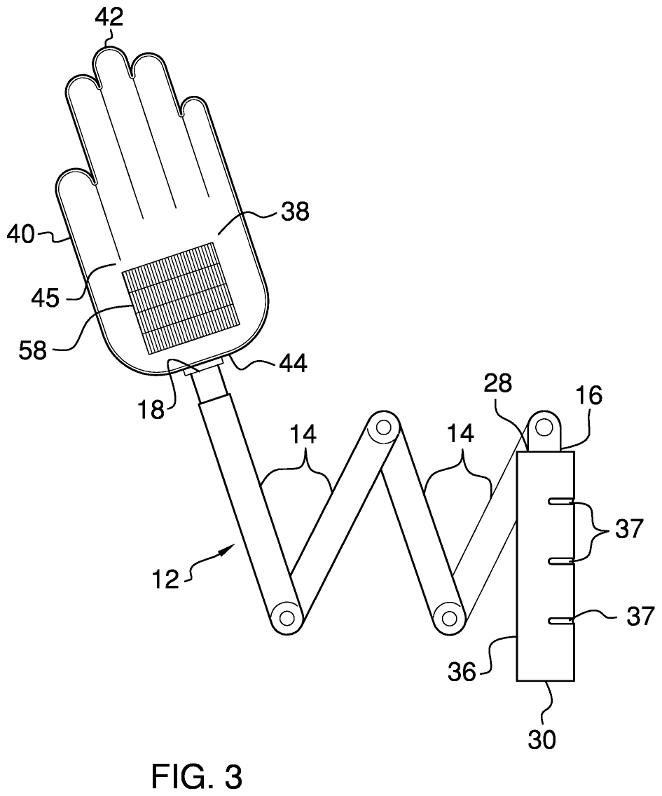

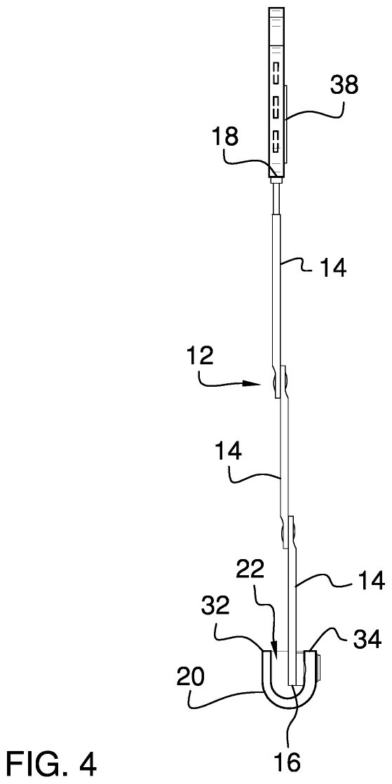

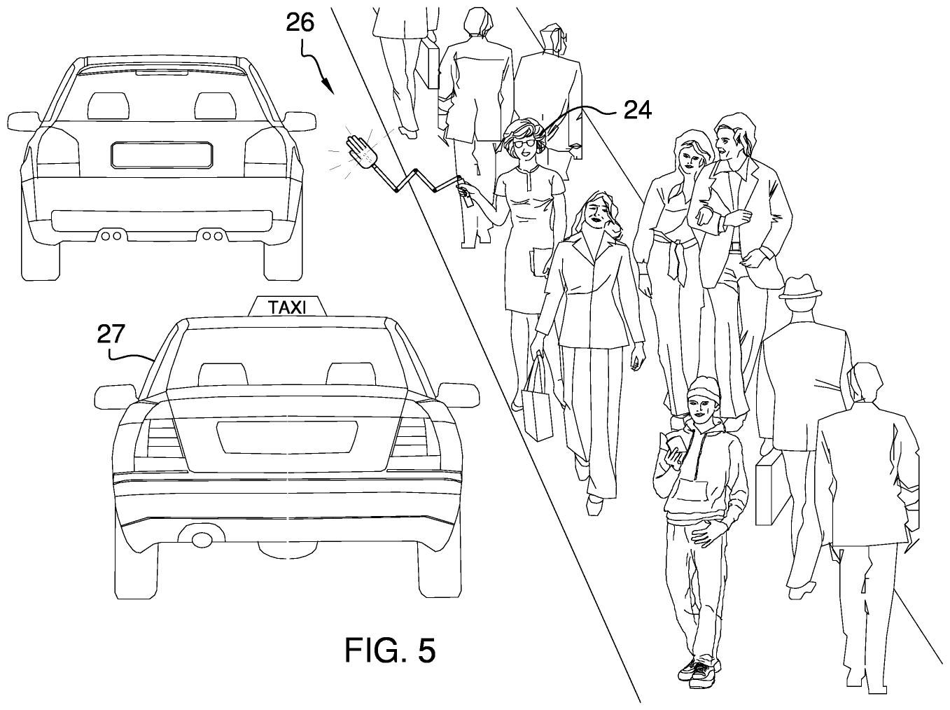

With reference now to the drawings, and in particular to FIGS. 1 through 5 thereof, a new hailing device embodying the principles and concepts of an embodiment of the disclosure and generally designated by the reference numeral 10 will be described.

As best illustrated in FIGS. 1 through 5, the taxi cab hailing assembly 10 generally comprises an arm 12 has a plurality of sections 14 that are each pivotally coupled together. The arm 12 is positionable in an extended position or a collapsed position, and the arm 12 has a primary end 16 and a secondary end 18. A handle 20 is provided and the arm 12 is pivotally coupled to the handle 20. The handle 20 has a recess 22 integrated therein and the arm 12 is positioned in the recess 22 when the arm 12 is positioned in the collapsed position for storage. The handle 20 is gripped by a user 24 thereby facilitating the arm 12 to be extended outwardly toward a roadway 26 when the arm 12 is in the extended position. The roadway 26 may be a city road or any other public road where a user 24 would be likely to hail a taxi 27.

The handle 20 has a first end 28 and a second end 30. The handle 20 has a first edge 32 extending between the first end 28 and the second end 30, and the handle 20 has a second edge 34 extending between the first end 28 and the second end 30. Moreover, the handle 20 is curved having the first edge 32 being spaced from the second edge 34 such that the handle 20 forms a saddle shape. In this way the recess 22 is defined between the first edge 32 and the second edge 34. The primary end 16 of the arm 12 is pivotally coupled to a pivot point 36 that is positioned in the recess 22. The handle 20 has a plurality of grooves 37 that are distributed between the first end 28 and the second end 30 for enhancing gripping the handle 20.

A panel 38 is coupled to the arm 12 thereby facilitating the panel 38 be extended outwardly toward the roadway 26 when the arm 12 is in the extended position. The panel 38 has an outer edge 40 and the outer edge 40 is structured to define the outline of a human hand. In this way the panel 38 can visually alert a driver of the taxi 27 that the user 24 needs a taxi 27. The outer edge 40 has an upper side 42 and the upper side 42 undulates such that the upper side 42 suggests the ornamental appearance of finger tips of a human hand that is positioned to signal “stop”. The outer edge 40 has a lower side 44 and the lower side 44 is coupled to the secondary end 18 of the arm 12, and the panel 38 has a front side 43 and a back side 45.

A light emitter 46 is integrated into the panel 38 and the light emitter 46 emits light when the light emitter 46 is turned on. In this way the light emitter 46 enhances visibility of the panel 38 to a driver of the taxi 27 by emitting light into the interior of the panel 38. In this way the entire panel 38 is illuminated to maximize visibility of the panel 38. The light emitter 46 may comprise an LED or the like and the light emitter 46 may blink on and off in a variety of pre-selected patterns. A switch 48 is slidably coupled to the handle 20, the switch 48 is electrically coupled to the light emitter 46 and the switch 48 turns the light emitter 46 on and off. Additionally, the light emitter 46 may emit light in a variety of colors that are associated with taxi cabs, rideshare vehicles or any other specific type of vehicle.

An alarm 50 is coupled to the handle 20 and the alarm 50 emits an audible alert when the alarm 50 is turned on. The alarm 50 may include an electronic speaker or other electronic alarm that has an operational volume of at least 80.0 decibels. Additionally, the alarm 50 may emit a variety of different sounding alarm patterns. A panic button 52 is movably coupled to the handle 20, the panic button 52 is electrically coupled to the alarm 50 and the alarm 50 is turned on when the panic button 52 is depressed. In this way the alarm 50 emits the audible alert when the user 24 feels threatened or distressed.

A power supply 54 is integrated into the handle 20, the power supply 54 is electrically coupled to the switch 48 and the panic button 52 and the power supply 54 comprises at least one battery 56. Additionally, the power supply 54 includes a solar panel 58 that is positioned on the back side 45 of the panel thereby facilitating the solar panel to be exposed to sunlight. The solar panel 58 is electrically coupled to the at least one battery 56 for charging the at least one battery 56.

In use, the arm 12 is positioned in the extended position to extend the panel 38 outwardly over the roadway 26 for hailing a taxi 27. In this way the user 24 can stand safely on the sidewalk while hailing a taxi 27. Additionally, the light emitter 46 can be turned on for illuminating the panel 38 at night. The panic button 52 can be depressed any time the user 24 wishes to sound the alarm 50 for alerting bystanders to a potentially dangerous situation for the user 24. The arm 12 is positioned in the collapsed position for storage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A taxi cab hailing assembly being configured to facilitate a user to visually alert a taxi for a ride, said assembly comprising:
an arm having a plurality of sections each being pivotally coupled together in series defining a single end to end succession of said sections wherein said arm is positionable in an extended position or a collapsed position;
a handle having said arm being pivotally coupled thereto, said handle having a recess being integrated therein, said arm being positioned in said recess when said arm is positioned in said collapsed position for storage, said handle being gripped by a user wherein said arm is configured to extend outwardly toward a roadway when said arm is in said extended position;
a panel being coupled to said arm thereby facilitating said panel be extended outwardly toward the roadway when said arm is in said extended position, said panel having an outer edge, said outer edge being structured to define the outline of a human hand wherein said panel is configured to visually alert a taxi driver that the user needs a taxi;
a light emitter being integrated into said panel, said light emitter emitting light when said light emitter is turned on wherein said light emitter is configured to enhance visibility of said panel to the taxi driver;
an alarm being coupled to said handle, said alarm emitting an audible alert when said alarm is turned on; and
a power supply coupled to said handle, said power supply being electrically coupled to said light emitter through said arm.

2. The assembly according to claim 1, wherein:
said arm has a primary end and a secondary end; and
said handle has a first end and a second end, said handle having a first edge extending between said first end and said second end, said handle having a second edge extending between said first end and said second end, said handle being curved having said first edge being spaced from said second edge such that said handle forms a saddle shape thereby defining said recess between said first edge and said second edge, said primary end of said arm being pivotally coupled to a pivot point being positioned in said recess.

3. The assembly according to claim 2, wherein said outer edge has an upper side, said upper side undulating such that said upper side suggests the ornamental appearance of finger tips of a human hand that is positioned to signal “stop”, said outer edge having a lower side, said lower side being coupled to said secondary end of said arm.

4. The assembly according to claim 2, further comprising a switch being slidably coupled to said handle, said switch being electrically coupled to said light emitter, said switch turning said light emitter on and off.

5. The assembly according to claim 4, further comprising a panic button being movably coupled to said handle, said panic button being electrically coupled to said alarm, said alarm being turned on when said panic button is depressed for emitting said audible alert when the user feels threatened or distressed.

6. The assembly according to claim 5, further comprising said power supply being integrated into said handle, said power supply being electrically coupled to said switch and said panic button, said power supply comprising at least one battery.

7. A taxi cab hailing assembly being configured to facilitate a user to visually alert a taxi for a ride, said assembly comprising:
an arm having a plurality of sections each being pivotally coupled together in series defining a single end to end succession of said sections wherein said arm is positionable in an extended position or a collapsed position, said arm having a primary end and a secondary end;
a handle having said arm being pivotally coupled thereto, said handle having a recess being integrated therein, said arm being positioned in said recess when said arm is positioned in said collapsed position for storage, said handle being gripped by a user wherein said arm is configured to extend outwardly toward a roadway when said arm is in said extended position, said handle having a first end and a second end, said handle having a first edge extending between said first end and said second end, said handle having a second edge extending between said first end and said second end, said handle being curved having said first edge being spaced from said second edge such that said handle forms a saddle shape thereby defining said recess between said first edge and said second edge, said primary end of said arm being pivotally coupled to a pivot point being positioned in said recess;
a panel being coupled to said arm thereby facilitating said panel be extended outwardly toward the roadway when said arm is in said extended position, said panel having an outer edge, said outer edge being structured to define the outline of a human hand wherein said panel is configured to visually alert a taxi driver that the user needs a taxi, said outer edge having an upper side, said upper side undulating such that said upper side suggests the ornamental appearance of finger tips of a human hand that is positioned to signal “stop”, said outer edge having a lower side, said lower side being coupled to said secondary end of said arm;
a light emitter being integrated into said panel, said light emitter emitting light when said light emitter is turned on wherein said light emitter is configured to enhance visibility of said panel to the taxi driver;
a switch being slidably coupled to said handle, said switch being electrically coupled to said light emitter, said switch turning said light emitter on and off;
an alarm being coupled to said handle, said alarm emitting an audible alert said alarm is turned on;
a panic button being movably coupled to said handle, said panic button being electrically coupled to said alarm, said alarm being turned on when said panic button is depressed for emitting said audible alert when the user feels threatened or distressed; and
a power supply being integrated into said handle, said power simply being electrically coupled to said light emitter through said arm, said power supply being electrically coupled to said switch and said panic button, said power supply comprising at least one battery.
